(19) United States
(12) Patent Application Publication
(10) Pub. No.: US 2025/0158162 A1
(43) Pub. Date: May 15, 2025

(54) BATTERY PACK

(71) Applicant: TOYOTA JIDOSHA KABUSHIKI KAISHA, Toyota-shi (JP)

(72) Inventor: Takuya TOMIOKA, Toyota-shi (JP)

(73) Assignee: TOYOTA JIDOSHA KABUSHIKI KAISHA, Toyota-shi (JP)

(21) Appl. No.: 18/771,109

(22) Filed: Jul. 12, 2024

(30) Foreign Application Priority Data
Nov. 14, 2023 (JP) 2023-193896

(51) Int. Cl. H01M 10/6566; H01M 10/613; H01M 10/625; H01M 50/209

(52) U.S. Cl. CPC H01M 10/6566; H01M 10/613; H01M 10/625; H01M 50/209; H01M 2220/20

(57) ABSTRACT

The battery pack includes a battery stack, a battery case that houses the battery stack, an intake chamber, an exhaust chamber, and flow regulation plates provided in the intake chamber. The battery stack is configured by stacking battery cells and has a cooling air passage. The intake chamber is positioned below the battery stack in the battery case, communicates with the cooling air passage, and receives supply of cooling air flowing from an intake port formed at one end in a stacking direction of the battery cells to another end in the stacking direction. The exhaust chamber is positioned above the battery stack in the battery case and communicates with the cooling air passage. The flow regulation plates are positioned on a downstream side of the cooling air, respectively formed to extend in the stacking direction, and disposed at intervals in a direction orthogonal to the stacking direction.

### CROSS-REFERENCE TO RELATED APPLICATION

This application claims priority to Japanese Patent Application No. 2023-193896 filed on Nov. 14, 2023, incorporated herein by reference in its entirety.

### BACKGROUND

### 1. Technical Field

The present disclosure relates to a structure for cooling a battery pack.

### 2. Description of Related Art

Japanese Unexamined Patent Application Publication No. 2017-097964 (JP 2017-097964 A) discloses a battery cooling system. The battery cooling system includes a battery stack in which a cooling air passage is provided between battery modules, and an intake chamber and an exhaust chamber that are disposed such that the battery stack is disposed between the intake chamber and the exhaust chamber. The exhaust chamber has an air vent for allowing cooling air to flow to the outside of the battery cooling system.

### SUMMARY

The intake chamber according to JP 2017-097964 A is configured to receive the supply of cooling air flowing from an intake port formed at one end in a stacking direction of a plurality of battery cells to the other end in the stacking direction. Therefore, the cooling air may come into contact with a wall surface on a downstream side of the intake chamber to generate a swirl. The generated swirl may cause the cooling air to stay, resulting in a rise in the temperature of the cooling air.

The present disclosure has been made in view of the above issue, and an object of the present disclosure is to provide a battery pack capable of suppressing the generation of a swirl on a downstream side of an intake chamber to suppress a rise in the temperature of cooling air.

A battery pack according to the present disclosure includes a battery stack, a battery case, an intake chamber, an exhaust chamber, and a plurality of flow regulation plates. The battery stack is configured by stacking a plurality of battery cells, and includes a cooling air passage between the battery cells adjacent to each other. The battery case houses the battery stack. The intake chamber is positioned below the battery stack in the battery case, is communicated with the cooling air passage, and receives supply of cooling air flowing from an intake port provided at one end in a stacking direction of the battery cells to another end in the stacking direction. The exhaust chamber is positioned above the battery stack in the battery case, and is communicated with the cooling air passage. The flow regulation palates are provided in the intake chamber. The flow regulation plates are positioned on a downstream side to which the cooling air flows. Each of the flow regulator plates extends along the stacking direction. The flow regulation plates are disposed at intervals in a direction orthogonal to the stacking direction in a top view of the battery stack.

According to the present disclosure, with the flow regulation plates provided in the intake chamber, it is possible to suppress the generation of a swirl on the downstream side of the intake chamber to suppress a rise in the temperature of the cooling air.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a battery pack according to an embodiment;

FIG. 2 is a diagram schematically showing a configuration of a battery pack according to a comparative example; and

FIG. 3 is a cross-sectional view taken along line A-A of the battery pack shown in FIG. 1.

### DETAILED DESCRIPTION OF EMBODIMENTS

### 1. Configuration of Battery Pack

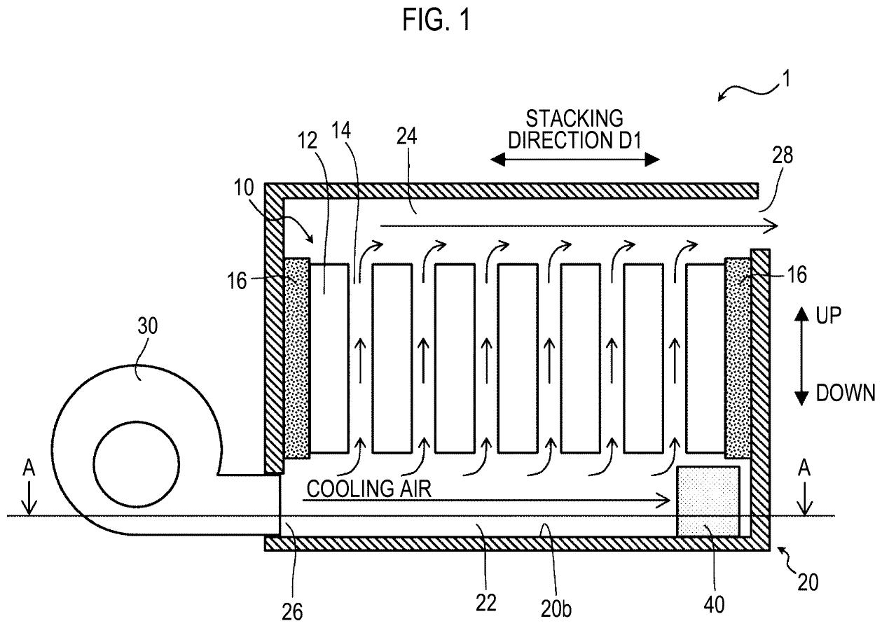

FIG. 1 is a diagram schematically showing a configuration of a battery pack 1 according to an embodiment. The battery pack 1 is mounted on an electrified vehicle, such as a hybrid electric vehicle (HEV) or a battery electric vehicle (BEV).

The battery pack 1 includes a battery stack 10 and a battery case 20. The battery case 20 accommodates the battery stack 10. The battery stack 10 is configured by stacking a plurality of battery cells 12. A stacking direction D1 of the battery cells 12 coincides with the longitudinal direction of the battery stack 10. For example, each battery cell 12 is a prismatic cell, and the battery stack 10 has a substantially rectangular parallelepiped shape. Further, the battery case 20 has a substantially rectangular parallelepiped shape along the shape of the battery stack 10.

The battery stack 10 includes a spacer (not shown) disposed between adjacent battery cells 12. The battery stack 10 has a cooling air passage 14 formed using the spacer. The battery stack 10 includes a pair of end plates 16 positioned at both ends of the stacking direction D1, and is supported by a battery case 20 through the pair of end plates 16.

An intake chamber 22 and an exhaust chamber 24 are formed inside the battery case 20. As shown in FIG. 1, a space positioned below the battery stack 10 is formed as an intake chamber 22. The intake chamber 22 communicates with the cooling air passage 14. A space positioned above the battery stack 10 is formed as an exhaust chamber 24. The exhaust chamber 24 communicates with the cooling air passage 14. More specifically, the intake chamber 22 is provided adjacent to a lower surface of the battery stack 10 and is surrounded by the battery case 20 together with the lower surface. The exhaust chamber 24 is provided adjacent to the upper surface of the battery stack 10 and is surrounded by the upper surface and the battery case 20.

The intake chamber 22 has an intake port 26. The intake port 26 is formed by the battery case 20 at one end in the stacking direction D1. The exhaust chamber 24 has an exhaust port 28. As an example, the exhaust port 28 is formed in the battery case 20 at another end in the stacking direction D1.

The battery pack 1 is provided with a blower 30 that generates a cooling air inside the battery case 20. The blower 30 is, for example, a discharge type blower or a fan connected to the intake port 26. As shown in FIG. 1, the blower 30 supplies the cooling air to the intake chamber 22 such that the cooling air flows in the stacking direction D1 in the intake chamber 22. In other words, the intake chamber 22 receives the supply of the cooling air flowing from the intake port 26 formed at one end of the stacking direction D1 toward the other end of the stacking direction D1.

When the blower 30 operates to cool the battery cells 12, as shown in FIG. 1, the cooling air introduced from the intake port 26 flows into each cooling air passage 14 while flowing through the inside of the intake chamber 22 in the stacking direction D1. Then, the cooling air passing through each cooling air passage 14 flows out to the exhaust chamber 24, flows through the inside of the exhaust chamber 24 along the stacking direction D1, and is discharged to the outside through the exhaust port 28.

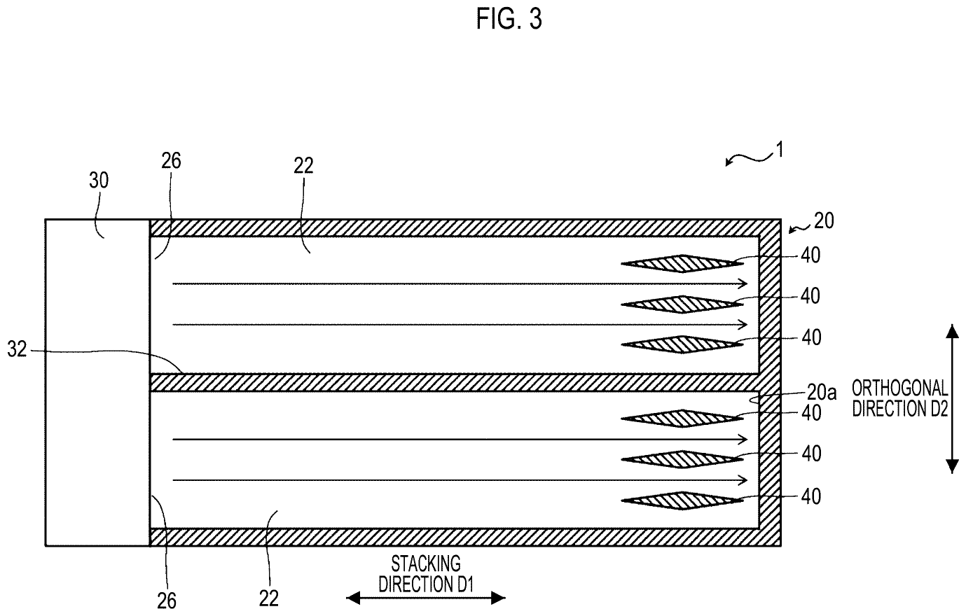

The number of battery stacks 10 included in the battery pack 1 is not particularly limited, but as an example, two battery stacks 10 are disposed side by side in a direction of depth of the paper of FIG. 1. The intake chamber 22 and the intake port 26 are formed for each battery stack 10 through a partition plate 32 (see FIG. 3 described below) provided in the battery case 20.

The battery pack 1 further includes a plurality of rectifier plates 40. The detailed configuration of the rectifier plates 40 will be described later with reference to FIG. 3 together with FIG. 1.

### 2. Comparative Example

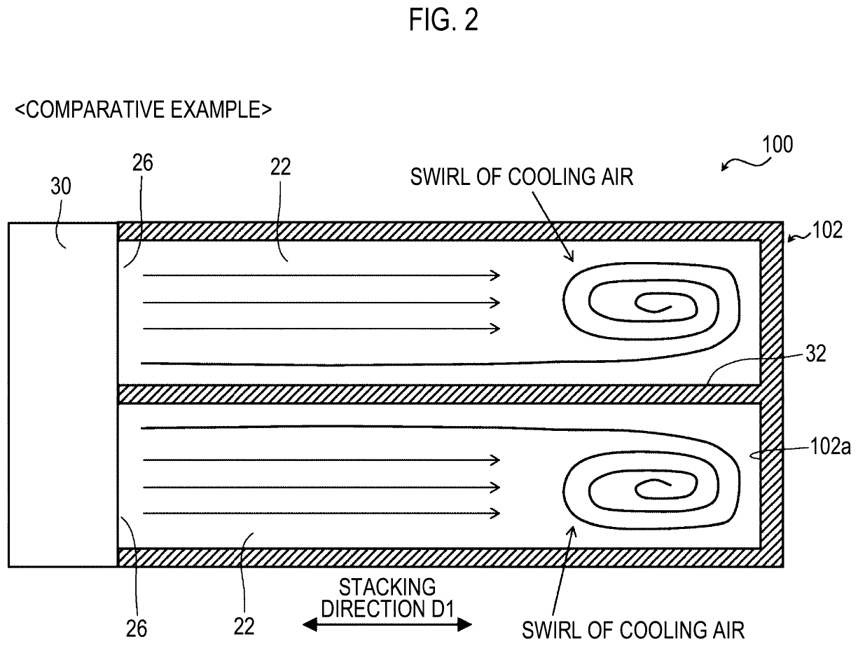

FIG. 2 is a diagram schematically showing a configuration of a battery pack 100 according to a comparative example. The battery pack 100 is configured in the same manner as the battery pack 1 shown in FIG. 1 except that the battery pack 100 does not include the rectifier plates 40. FIG. 2 is a cross-sectional view of the battery case 102 of the battery pack 100 cut along the same position as the A-A line shown in FIG. 1. This comparative example is referred to for describing a problem of the battery pack 100 having no rectifier plates 40.

A part of the cooling air supplied to the intake chamber 22 by the blower 30 flows along the stacking direction D1, hits a wall surface 102a of a downstream side, and is reflected. As a result, as shown in FIG. 2, a swirl of the cooling air is generated on the downstream side of the intake chamber 22 (more specifically, in the vicinity of the wall surface 102a). The generation of the swirl causes a part of the cooling air to stay in the intake chamber 22 for a long time. As a result, the cooling air temperature increases. The increase in the cooling air temperature leads to the deterioration of the cooling of the battery cells 12.

### 3. Rectifier Plate

FIG. 3 is a cross-sectional view taken along line A-A of the battery pack 1 shown in FIG. 1. As shown in FIGS. 1 and 3, a plurality of rectifier plates 40 is provided in the intake chamber 22. In the example shown in FIG. 3, as an example, three rectifier plates 40 are provided inside each of the intake chambers 22.

Hereinafter, the configuration of the rectifier plate 40 will be described with reference to each intake chamber 22.

The three rectifier plates 40 are positioned on the downstream side of the cooling air in the intake chamber 22. More specifically, the three rectifier plates 40 are disposed in the vicinity of the wall surface 20a of the battery case 20, which is positioned on the opposite side of the blower 30 in the stacking direction D1, that is, at the end portion of the downstream side. That is, when the three rectifier plates 40 are focused on in the stacking direction D1, the three rectifier plates 40 are provided at a position where a swirl is generated in a case where the three rectifier plates 40 are not provided (see FIG. 2). In addition, when the stacking direction D1 (that is, the flow direction of the cooling air) is focused on, the three rectifier plates 40 are not provided upstream of the end portion of the downstream side of the cooling air, in other words, are provided solely at the end portion of the downstream side.

In addition, each of the three rectifier plates 40 is formed to extend along the stacking direction D1. For example, the three rectifier plates 40 are formed to have the same shape and size. In addition, in the top view of the battery stack 10 shown in FIG. 3, the three rectifier plates 40 are disposed at intervals in an orthogonal direction D2 orthogonal to the stacking direction D1.

More specifically, in the example shown in FIG. 3, the three rectifier plates 40 are disposed to be spaced apart from each other by a “constant interval” in the orthogonal direction D2. In addition, the predetermined interval described herein includes not only an example in which the interval is completely constant but also an example in which the interval is substantially constant.

Further, the three rectifier plates 40 are formed as three ribs protruding upward from the wall surface 20b (see FIG. 1) of the battery case 20. The wall surface 20b is a wall surface of the battery case 20 that forms the bottom surface of the intake chamber 22, and faces the battery stack 10. In addition, the three rectifier plates 40 that are the three ribs are formed integrally with the battery case 20, but may be formed by a member separate from the battery case 20. The heights of the three rectifier plates 40 are not particularly limited, but the three rectifier plates 40 are formed to extend over the entire vertical direction of the intake chamber 22, for example, as shown in FIG. 1.

In addition, in the example shown in FIG. 3, in the top view of the battery stack 10, each of the three rectifier plates 40 is formed to have a rhombus shape long in the stacking direction D1. Note that the shape of each rectifier plate 40 in the top view of the battery stack 10 is not necessarily limited to the rhombus shape as long as the shape is a plate shape that extends along the stacking direction D1.

### Effects

The battery pack 1 according to the present embodiment described above rectifies the cooling air that reaches the positions of the rectifier plates 40, as indicated by the arrows in FIG. 3, by passing through the gaps between the adjacent rectifier plates 40. As a result, the generation of a large swirl as shown in FIG. 2 can be suppressed. As a result, a part of the cooling air is suppressed from staying for a long time on the downstream side in the intake chamber 22, and thus the temperature increase of the cooling air can be suppressed. It leads to the improvement of the cooling of the battery cells 12.

In addition, broadly speaking, the intervals between the rectifier plates 40 in the orthogonal direction D2 do not have to be constant. On the other hand, in the example shown in FIG. 3, the rectifier plates 40 are disposed at regular intervals in the orthogonal direction D2. As a result, the rectification effect can be further enhanced as compared with a case where the interval is not constant and is irregular, so that the generation of a large swirl as shown in FIG. 2 can be more effectively suppressed.

In addition, broadly speaking, the rectifier plates 40 do not necessarily have to be formed as ribs extending from the wall surface 20b of the battery case 20. That is, for example, the rectifier plates 40 may be supported by a pillar extending from the side surface of the battery case 20, such as the wall surface 20a. On the other hand, in the example shown in FIG. 3, the rectifier plates 40 are formed as ribs extending from the wall surface 20b of the battery case 20. As a result, the production of the rectifier plates 40 can be easily performed, and the temperature increase of the cooling air can be suppressed.

What is claimed is:

1. A battery pack comprising:
a battery stack that is configured by stacking a plurality of battery cells and includes a cooling air passage between the battery cells adjacent to each other;
a battery case that houses the battery stack;
an intake chamber that is positioned below the battery stack in the battery case, is communicated with the cooling air passage, and receives supply of cooling air flowing from an intake port provided at one end in a stacking direction of the battery cells to another end of in stacking direction;
an exhaust chamber that is positioned above the battery stack in the battery case, and is communicated with the cooling air passage; and
a plurality of flow regulation plates provided in the intake chamber, wherein
the flow regulation plates are positioned on a downstream side to which the cooling air flows, each of the flow regulation plates extends along the stacking direction, and the flow regulation plates are disposed at intervals in a direction orthogonal to the stacking direction in a top view of the battery stack.

2. The battery pack according to claim 1, wherein the intervals are fixed.

3. The battery pack according to claim 1, wherein the flow regulation plates are a plurality of ribs that protrude upward from a wall surface of the battery case, the wall surface being a bottom surface of the intake chamber.
